(19) United States
(12) Patent Application Publication
(10) Pub. No.: US 2019/0256716 A1
(43) Pub. Date: Aug. 22, 2019

(54) Superhydrophobic Polymer Compositions and Uses Thereof

(71) Applicant: Universite de Mons, Mons (BE)

(72) Inventors: Joel De Coninck, Mons (BE); Connie Josefina Ocando Cordero, Mons (BE)

(73) Assignee: Universite de Mons, Mons (BE)

(21) Appl. No.: 16/311,483

(22) PCT Filed: Jun. 20, 2017
(86) PCT No.: PCT/EP2017/065104

§ 371 Date: Dec. 19, 2018

(30) Foreign Application Priority Data
Jun. 20, 2016 (GB) 1610678.3
Dec. 30, 2016 (GB) 1622380.2

(51) Int. Cl. C09D 5/00; C09D 183/04; C09D 163/00; C09D 123/12; C09D 125/06

(52) U.S. Cl. CPC C09D 5/00; C09D 183/04; C09D 125/06; C09D 123/12; C09D 163/00

(57) ABSTRACT

This disclosure relates to a superhydrophobic coating composition including a solution of crystalline and/or semi-crystalline polymer, for example polypropylene, and of an amorphous hydrophobic matrix polymer in a solvent. The coating is robust, resistant to wear, and may be translucent. The disclosure further relates to an article coated with a superhydrophobic coating composition as previously described and a process for preparing the same.

The present invention relates to superhydrophobic polymer compositions, their use as superhydrophobic coatings, as well as their method of preparation.

Superhydrophobicity has gained considerable attention in surface science in the past 20 years. Superhydrophobicity is characterized by unique water-repellent properties, combined with a self-cleaning effect. Reference is made to the review article by R. Rioboo, B. Delattre, D. Duvivier, A. Vaillant and J. De Coninck, “Superhydrophobicity and liquid repellency of solutions on polypropylene”, Adv. Colloid. Interfac., 2012, 175, 1-10. As used herein the term “superhydrophic surface” means a surface having i) a receding static water contact angle (a 50 μl water droplet on a flat surface in an essentially horizontal plane) of more than 135°, preferably more than 140° or more than 145°, more preferably from 145° to 160°, and ii) an advancing static water contact angle of more than 135°, preferably more than 140° or more than 145°, and more preferably from 145° to 160°, as measured by a Drop Shape Krüss Analyser and corresponding protocol and iii) preferably a water roll-off angle also called sliding angle (dynamic measure) of less than 10°, preferably less than 6°.

When a pipette is used to provide a liquid drop on a flat horizontal surface, the liquid will form a contact angle. As the pipette deposits more liquid, the droplet will increase in volume, the contact angle will increase, but its three phase boundary will remain stationary until it suddenly advances outward. The contact angle the droplet had immediately before advancing outward is termed the advancing contact angle. The receding contact angle is measured by pumping the liquid back out of the droplet. The droplet will decrease in volume, the contact angle will decrease, but its three phase boundary will remain stationary until it suddenly recedes inward. The contact angle the droplet had immediately before receding inward is termed the receding contact angle. The difference between advancing and receding contact angles is termed contact angle hysteresis and can be used to characterize surface heterogeneity, roughness, and mobility. Surfaces that are not homogeneous will have domains which impede motion of the contact line. The slide angle is another dynamic measure of hydrophobicity and is measured by depositing a droplet on a surface and tilting the surface until the droplet begins to slide—http://en.wikipedia.org/wiki/Superhydrophobe—Jan. 6, 2015. Langmuir 2004, 20, 3517-3519.

Superhydrophobicity is known to be linked to the surface topography of the surface and several models have been designed to take surface aspects into consideration. While roughness is a useful indicator of the probability for a given surface to be superhydrophobic, it is, in practice, difficult to determine the superhydrophobic character on the basis of surface aspects alone. It is therefore preferred to define superhydrophobicity on the basis of the receding static water contact angle and water sliding angle and stability of these properties, that is independently of the application method of the water droplet. Moreover, the SuperHydrophobic Index which provides an indication of the percentage of surface area which is actually superhydrophobic is also an important aspect in considering the superhydrophobic property of a surface.

It is known that ground crystallized polypropylene particles (including but not limited to particles of homopolymers, copolymers, such as ethylene-propylene block copolymers, random copolymers, graft copolymers, such as grafted with maleic anhydride or acrylic acid, halogenated polypropylene, surface oxidized polypropylene) show superhydrophobic properties; that is that ground crystallized polypropylene particles deposited or otherwise attached onto a substrate form a superhydrophobic surface . The polypropylene may be crystallized by evaporation of the solvent of a polypropylene solution and then ground to an appropriate granular size, such as comprised between 0.1 μm and 50 μm. Superhydrophobic polypropylene particles may be used in the preparation of construction materials, insulation materials, or in coatings.

Despite the fact that polypropylene may be recovered from recycled plastic material, sourcing is relatively limited and/or costly and life cycle requirements tend to impose a reduction in consumption of polypropylene. There is thus a need to reduce the consumption of crystallized polymer in the preparation of superhydrophobic surfaces, while not substantially imparing the superhydrophobic properties of the material.

US2010/0316806 discloses anti-frost coatings that form a hydrophilic and hydrophobic composite structure when applied on a substrate, such that the inner layer of the coating is a hydrophilic polymer layer and the surface layer is a hydrophobic or superhydrophobic polymer layer. It is explained that as a result of the hydrophobic or superhydrophobic surface, the contact area between water droplets and coated substrate is reduced and the heat conduction is slow, thereby lengthening the transformation of condensed water drops into frost crystals. Also, owing to the hydrophobicity or superhydrophobicity, water droplets tend to roll off the coated surface, thereby reducing the amount of formed water crystals. Further, the hydrophilic character of the inner layer will adsorb water drops that permeate into the coating and that water will exist in the form of a gel which tends to prevent frost crystal formation. The teaching of the document heavily relies on the synergy between the hygroscopicity of the hydrophilic inner layer and the hydrophobicity or superhydrophobicity of the outer layer.

When seeking to provide superhydrophobic coating compositions, that is coating compositions that provide superhydrophobic properties to a substrate surface coated therewith, composite compositions comprising a hydrophilic polymer and a hydrophobic polymer may not be appropriate, because of inappropriate superhydrophobicity index (SHI) which is a measure of the percentage of surface area which actually is superhydrophobic

The superhydrophobicity index (SHI) is described in details in the reference R. Rioboo, B. Delattre, D. Duvivier, A. Vaillant et J. De Coninck, “Superhydrophobicity and liquid repellency of solutions on polypropylene”, Adv. Colloid. Interfac., 2012, 175, 1-10

The present invention now provides a superhydrophobic polymer or superhydrophobic polymer composite comprising a matrix of amorphous hydrophobic polymer and microparticles or nanoparticles of crystallized crystalline and/or semi-crystalline superhydrophobic polymer dispersed therein. The crystalline and/or semi-crystalline polymer is advantageously present in a weight ratio to the amorphous polymer such that the polymer composition shows superhydrophobic properties. The relevant ratio depends on the type and nature of the polymers chosen. The skilled person, however, will have no difficulty in identifying the suitable ratio after a series of routine tests as will be explained below. It has been found and will be shown in the Examples that for a PP/PVA blend for example, the receding contact angle suddenly jumps from about 20° to more than 135° at about 30 wt % PP. In a PP/PCP blend, the change from a hydrophobic to a superhydrophobic composition occurs between 60 and 70 wt % PP. In a PP/PS blend, the change from a hydrophobic composition to a superhydrophobic composition occurs at about 25 wt % PP. All that can be stated is that the superhydrophobic coating composition may comprise the crystalline and/or semi-crystalline polymer in a weight ratio to the amorphous polymer of 20:80 to 80:20, preferably 25:75 to 75:25, or 30:70 to 70:30, and always in such proportion that the polymer composition shows superhydrophobic properties. It has been found that at these ratios, the SHI is approx. 100%.

The crystalline and/or semi-crystalline superhydrophobic polymer may advantageously be selected from polypropylene (PP), preferably isotactic polypropylene, carnauba wax, polycarbonate (PC), polymethylmethacrylate (PMMA), polylactic acid (PLA), polyhydroxyalkanoates (PHA), polyhydroxybutyrate (PHB), polyimide (PA 11, PA 410), starch-based plastics, cellulose-based plastics, and fibrin-based plastics. Polypropylene and more specifically isotactic polypropylene is preferred. Such materials form fragile solid superhydrophobic material when solvent is evaporated from a polymer solution of relevant polymers. It has been found that the superhydrophobic character is linked to the rearrangement of the crystal structure of said polymers during solvent evaporation. The crystalline and/or semi-crystalline polymer may include homopolymers, copolymers, such as ethylene-propylene block copolymers, random copolymers, graft copolymers, such as polypropylene or polylactic acid grafted with maleic anhydride or acrylic acid, halogenated polymers, surface oxidized polymers, and other modifications known to the skilled person. The relevant polymers may be semi-crystalline, for example having a crystallinity index or degree of crystallinity of more than 30%, preferably more than 50%, more preferably greater than 75%, notably more than 80%. Said crystallinity index is usually defined as the percentage of the volume of the material that is actually crystalline and may be determined for example by solid NMR, X-ray diffraction or DSC.

The molecular weight of the crystalline or semi-crystalline polymer may vary within a large range of molecular weights, such as 1000 to 1000000 g/mol, preferably between 5000 and 500000 or more preferably between 5000 and 300000 g/mol.

The amorphous hydrophobic matrix polymer may advantageously be selected from polystyrene (PS), polyethylene (PE), preferably low density polyethylene (LDPE), and polychloroprene (PCP), and from polymers which are not hydrophobic by themselves but which are functionalized such as to be hydrophobic, like polyurethane (PU), polyvinylacetate (PVA), polyacrylic acid, polyacrylate,and epoxy resins. The crystalline or semi-crystalline polymer may further be incorporated into oil and solvent-based paints. As used herein, the term “amorphous polymer” means a polymer that is entirely amorphous or crystalline with a degree of crystallinity below 30%.

As used herein, the term hydrophobic polymer means a polymer that forms a hydrophobic surface, that is a surface showing a static contact angle with water of more than 90°. If the static contact angle is smaller than 90°, the surface and/or polymer forming it is said to be hydrophilic.

The term superhydrophobic polymer or superhydrophobic polymer composite as used herein means a polymer or polymeric composite which provides a superhydrophobic surface.

According to a preferred embodiment, the amorphous hydrophobic matrix polymer comprises a hydrophobic epoxy resin. Epoxy resins inherently are hydrophilic but may be rendered hydrophobic by chemical modification, crosslinking or other methods known per se.

As an example, the epoxy polymer may be fluorinated on the epoxy structure and/or on the crosslinling agent; e.g. a partially fluorinated amine curing agent. Fluorinated epoxy oligomers are know, see for instance heptadecafluorononyl oxirane of Sigma-Aldrich

Epoxy resins may be selected from high and low molecular weight epoxy resins curable by homopolymerisation or with a curing agent (or hardener) selected from polyfunctional amines, acids, alcohols and thiols. By way of example, suitable epoxy resins include bisphenol A epoxy resin, bisphenol F epoxy resin, novolac epoxy resin. A preferred hydrophobic epoxy resin is a biobased epoxydized material obtained from cardanol, for example NC-514.

According to a preferred embodiment, polymers are selected that are soluble in solvents selected from xylene, preferably p-xylene, or xylene based solvent systems, methyl ethyl ketone (see example), DMSO, toluene, THF, butylal, limonene . . . .

The polymer composite may comprise one or more additives and/or agents notably pigments, anti-fouling agents, wetting agents, thickening agents, hardening agents, toughening agents, plasticizers and stabilizers.

The superhydrophobic polymer composites may be used to form superhydrophobic coatings. Such coatings are known to provide unique water-repellent properties including self-cleaning properties, anti-icing and anti-condensation properties, impacting droplet rebounce combined with reduced air-resistance. The superhydrophobic polymer composites preferably show an SHI of from 70 to 100%, preferably of from 80 to 100%, even more preferably of from 90 to 100%, most preferably about 100%.

In preferred embodiments the composites or coatings maintain the above mentioned properties over extended periods of time. As will be evidenced in the examples, the coated surfaces show good resistance to severe stresses like friction and scratches, and substantially maintain superhydrophobic character after having been subjected to these stresses.

In another aspect, the present invention also relates to superhydrophobic coating compositions which comprise a solution of crystalline and/or semi-crystalline polymer and of an amorphous hydrophobic matrix polymer. Preferably, the solvent is selected from xylene, a xylene based solvent system, methyl ethyl ketone, DMSO, butylal , limonene or a mixture thereof. The coating composition advantageously comprises the crystalline and/or semi-crystalline polymer in a weight ratio to the amorphous polymer of 20:80 to 80:20, preferably 25:75 to 75:25, such that upon solvent evaporation the coating composition shows superhydrophobic properties.

The amorphous hydrophobic polymer and the crystalline or semi-crystalline polymer are selected from the respective groups of polymers defined above. In order to allow for formation of a superhydrophobic coating, the polymer concentration in the solvent of the coating composition is advantageously below 25 wt %, preferably between 5 and 15 wt %, more particularly around 10 wt %, prior to solvent evaporation. The coating composition also may comprise additives and/or agents notably as mentioned above in connection with the superhydrophobic polymer composition.

The coating compositions of the invention are particularly suitable to form a superhydrophobic coating of substrates, that is articles, notably: construction materials, for example concrete elements, metal, wood, bricks, tiles, roof membranes; self-cleaning textiles, more specifically sportswear, swimwear; self-cleaning matrasses or matrass covers.

It has been found that the hydrophobic polymer unexpectedly becomes superhydrophic when combined with superhydrophobic crystalline or semicrystalline polymer particles distributed within the hydrophobic polymer matrix. The superhydrophobic polymer particles may be obtained in a known manner by appropriate evaporation of the solvent of a polymer solution, under suitable conditions, in order to allow for crystal rearrangement which leads to crystal or semi-crystal polymer particles. If so required, the superhydrophobic crystal or semicrystal particles are ground to obtain the appropriate size distribution. The crystal particles may show number average particle sizes of less than 1000 μm, preferably less than 500 μm, or less than 100 μm, more preferably between 0.1 and 50 μm.

In order to prepare a coating composition, a solution of amorphous hydrophobic matrix polymer and crystalline or semi-crystalline polymer may be prepared in an appropriate solvent in a ratio above described and at a total polymer concentration of no more than 30 wt %, preferably no more than 25 wt %. The lower limit depends on the results to be achieved and on the desired efficiency of the coating process, transport costs etc. and selection thereof lies within the knowledge of the person skilled in the art, but should be at least 1 wt % or 2 wt %. The solution may be prepared at a temperature ranging from RT to a temperature below boiling point of the solvent.

The coating composition may be applied to a substrate and the solvent is then allowed to evaporate at a temperature comprised between 10 and 70° C., preferably between 10 and 50° C. After solvent evaporation, the superhydrophobic coating may still contain less than 5 w % solvent, preferably less than 3 w % solvent. The coated substrate may then be subjected to further drying. A curing step may be provided for too.

Evaporation and drying are preferably performed at atmospheric pressure. A pressure slightly above atmospheric is also possible, although not particularly preferred for practical reasons, it being understood that applying a pressure above atmospheric in the course of an industrial manufacturing process requires more expensive equipment, hence rendering the whole process more costly.

The coating composition may be applied onto the substrate by spraying, knife coating, dip coating or spin coating.

Surprisingly, when modifying the ratio of crystal or semi-crystal polymer to hydrophobic amorphous polymer, a dramatic change in surface wettability is observed in a very narrow range of crystal or semi-crystal polymer fraction. It has been found that the crystal or semi-crystal polymer fraction at which this dramatic change in surface wettability occurs may vary, depending on the polymers used. Taking a blend of isotactic polypropylene (PP, MW approx. 12000 g/mol) and polyvinyl acetate (PVA, MW approx. 100000 g/mol), the receding static contact angle suddenly jumps from approx. 20-30° to 140° and more at about 30/70 wt % PP/PVA. With a percentage above 30 wt % PP, the SHI is 100%, very close to what is observed for pure PP. Looking at a blend of polystyrene (PS, MW approx. 192000 g/mol) and PP, the same effect occurs around 25 wt % PP. looking at PP/PCP (polychloroprene) blends, the sharp rise in receding contact angle is noticed between 35 and 70 wt % PP.

The above coating operation may be repeated several times, preferably two or three times in order to form a multi-layered coating.

In an alternative embodiment, the coating obtained as described above may be overcoated with a layer of epoxy resin, preferably hydrophobic epoxy resin. The superhydrophobic coating retains its superhydrophobic character while showing improved resistance to abrasion and wear.

The coating composition may further comprise additives, such as pigments, rheology modifiers and others as are usual in coating and/or paint compositions.

The coating composition may further be incorporated in a paint composition, such as an epoxy based paint composition.

According to yet another aspect, the invention provides coated substrates that have been coated with a coating composition and/or bear a coating.

Superhydrophobic coating compositions as described above may be obtained by preparation of a solution of amorphous hydrophobic matrix polymer and crystalline or semi-crystalline polymer in a suitable solvent, in a ratio of 20:80 to 80:20, preferably 25:75 to 75:25 or 30:70 to 70:30, and at a total polymer concentration of at most 30 wt %, preferably of at most 25 wt %, at a temperature ranging from RT to a temperature below the boiling point of the solvent. This entails that the melting point of the hydrophobic amorphous polymer preferably is close to the boiling point of the solvent, more preferably below the boiling point of the solvent.

In some embodiments, the present invention provides polymer based coatings, including bio based polymers that show superhydrophobic character arising from a combination of intrinsic chemical hydrophobicity of the material and the hierarchically structured surface roughness. In accordance with some embodiments, the key to the appropriate roughness for superhydrophobicity lies within the self-organization process of the polypropylene crystallites in the matrix polymer as well as the migration of some of said crystallites into the coating-air interface, more particularly during solvent evaporation.

The provision of one pot solutions for surface treatment in order to render surfaces superhydrophobic is of particular interest. Coated articles as describrd herein may be made by preparing or providing a coating composition as described above and applying the said coating composition onto a substrate, and allowing the solvent to evaporate at a temperature comprised between 10 and 70° C. or between 10 and 50° C., and possibly curing. The invention coating compositions may thus be easily applied on all types of materials, including metals, concrete, polymeric materials and textiles.

Another important advantage of the invention consists in the fact that superhydrophobic compositions or coatings may be prepared that take benefit of intrinsic hydrophobicity and surface roughness without the inconveniences of manipulating microparticles and/or nanoparticles to generate the required surface roughness. Instead, the surface roughness is generated by cristallisation of polymer inside the hydrophobic matrix.

It has further been found that superhydrophobic coating compositions of the invention, more specifically those based on epoxy based amorphous hydrophobic matrix polymer, for example hydrophobized cardanol epoxy, may be translucent. This property is obviously of particular interest for applications on relevant substrates.

Superhydrophobic sheets, films or membranes may be formed by applying at least one superhydrophobic coating composition of the invention onto a suitable substrate, allowing for evaporation of the solvent at a temperature comprised between 10 and 70° C., preferably between 10 and 50° C. and withdrawal of the coating from the substrate. After solvent evaporation, the superhydrophobic coating may still contain less than 5 w % solvent, preferably less than 3 w % solvent. The coated substrate may be subjected to further drying and/or curing prior to withdrawal of the coating from the substrate. In such applications, one pot solutions are particularly preferred. The substrate may for instance be a steel substrate or a substrate inherently non-adherent or treated to be non-adherent for the coating composition applied. Preferably, the above coating operation is repeated several times, more preferably two or three times in order to form a multi-layered coating. In an alternative embodiment, and as already described with respect to the invention superhydrophobic coating, the latter obtained as described above may be overcoated with one or more layers of epoxy resin, preferably hydrophobic epoxy resin for enhanced abrasion and wear resistance.

The present invention will be described in more details below, by way of example only, with reference to the drawings of which

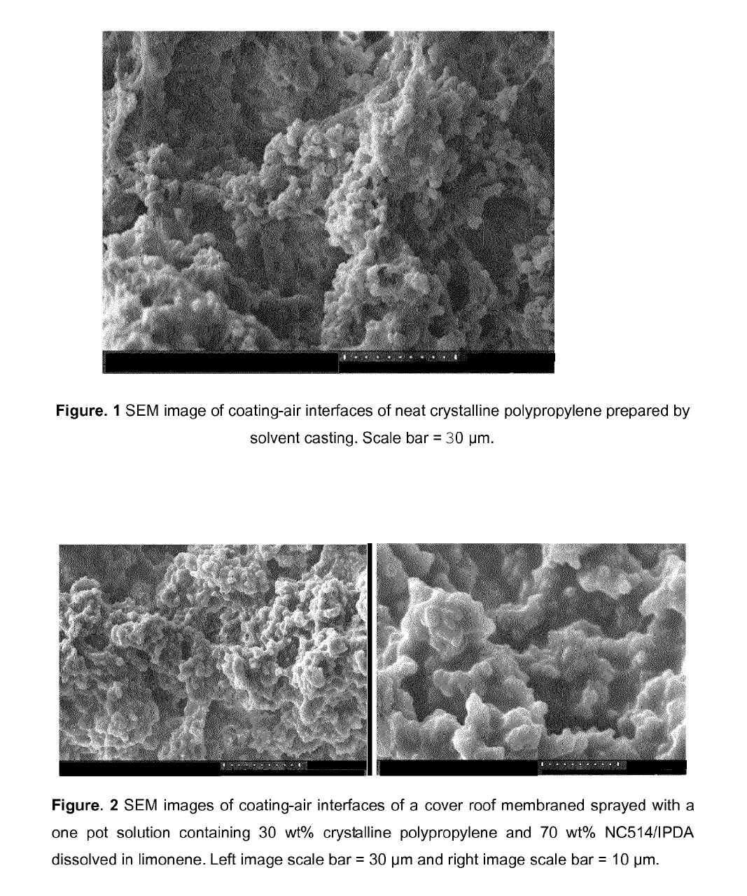

FIG. 1 is a SEM image of coating-air interfaces of neat crystalline polypropylene prepared by solvent casting;

FIG. 2 shows SEM images of coating-air interfaces of a cover roof membraned sprayed with a one pot solution containing 30 wt % crystalline polypropylene and 70 wt % NC514/IPDA dissolved in limonene;

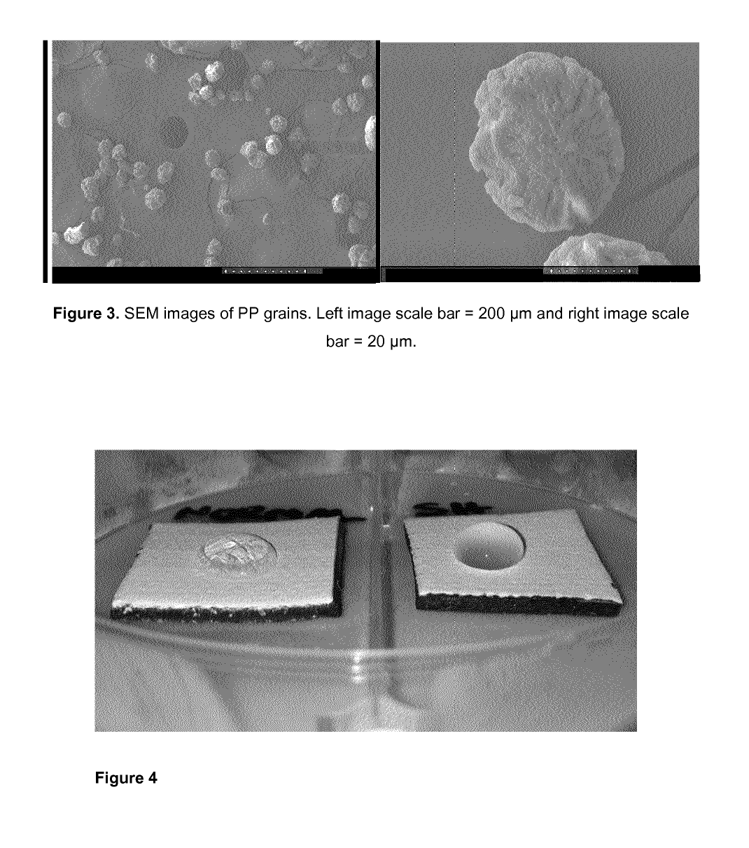

FIG. 3 shows SEM images of PP grains;

FIG. 4 shows a comparison between a non-coated and a coated roof membrane;

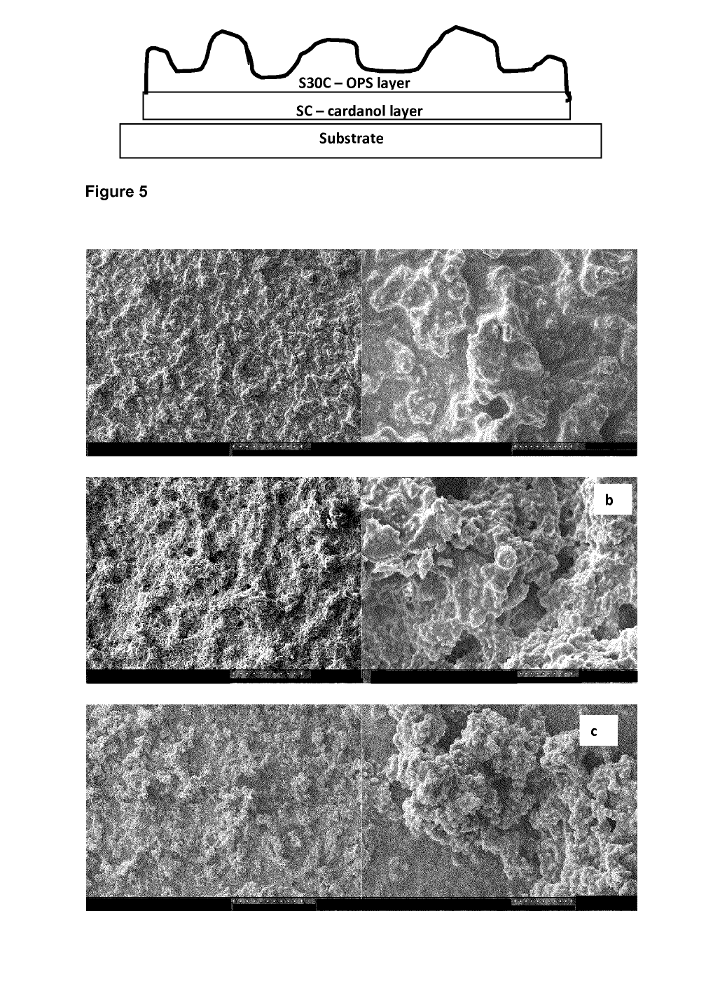

FIG. 5 is a schematic representation of the coating;

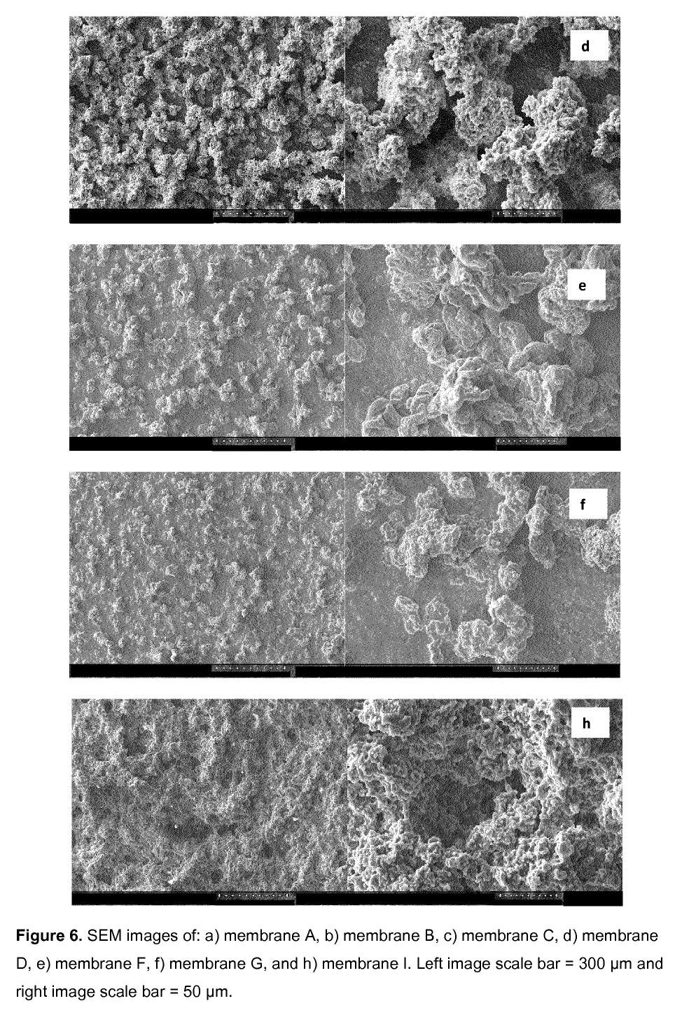

FIG. 6 shows shows the roughness morphology at the coating-air interface of the coated membranes determined by SEM;

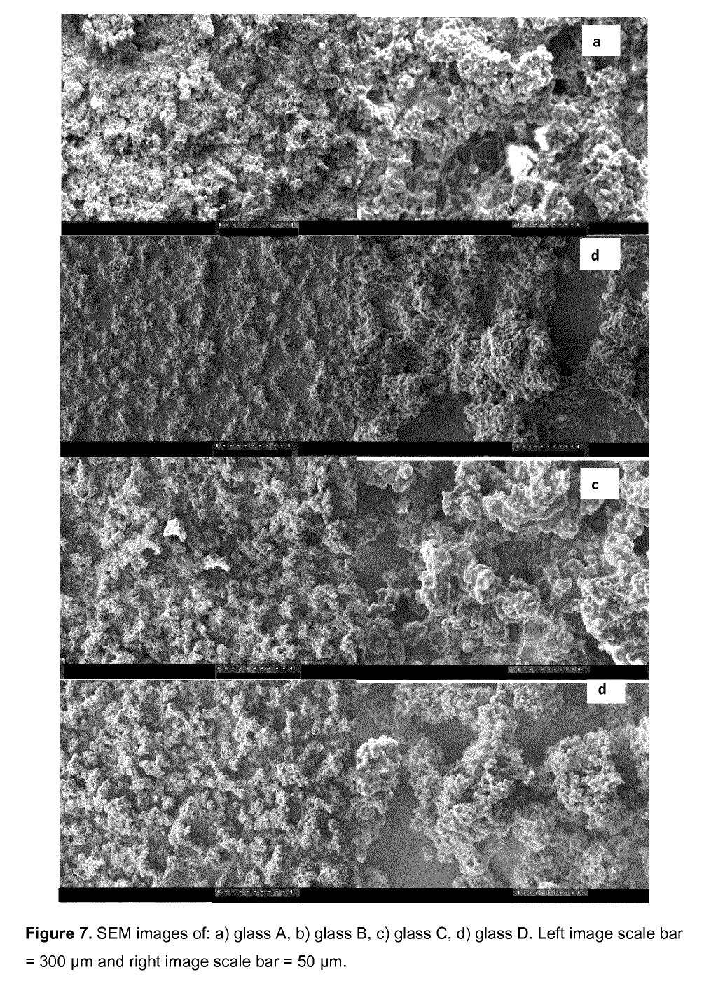

FIG. 7 shows the roughness morphology at the coating-air interface of the coated glass substrates determined by SEM;

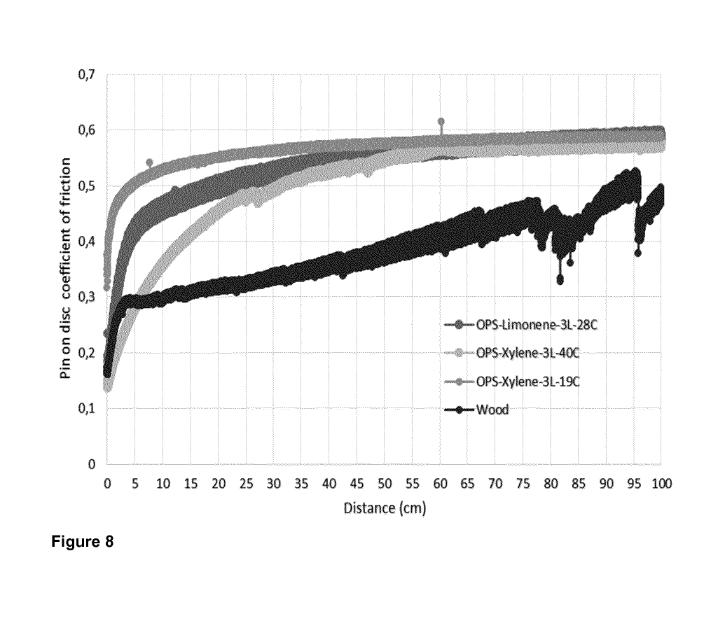

FIG. 8 is a graph showing the coefficient of friction with respect to the sliding distance for diverse sprayed wood substrates in a tribometer experiment;

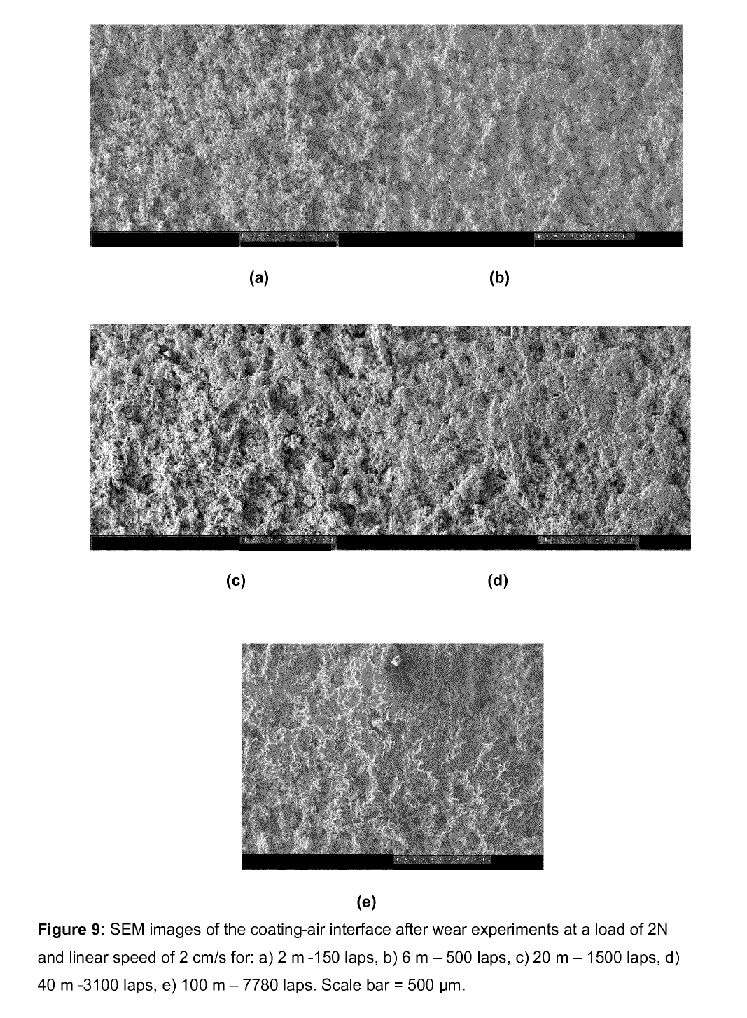

FIG. 9 shows wood surface morphologies after a wear test;

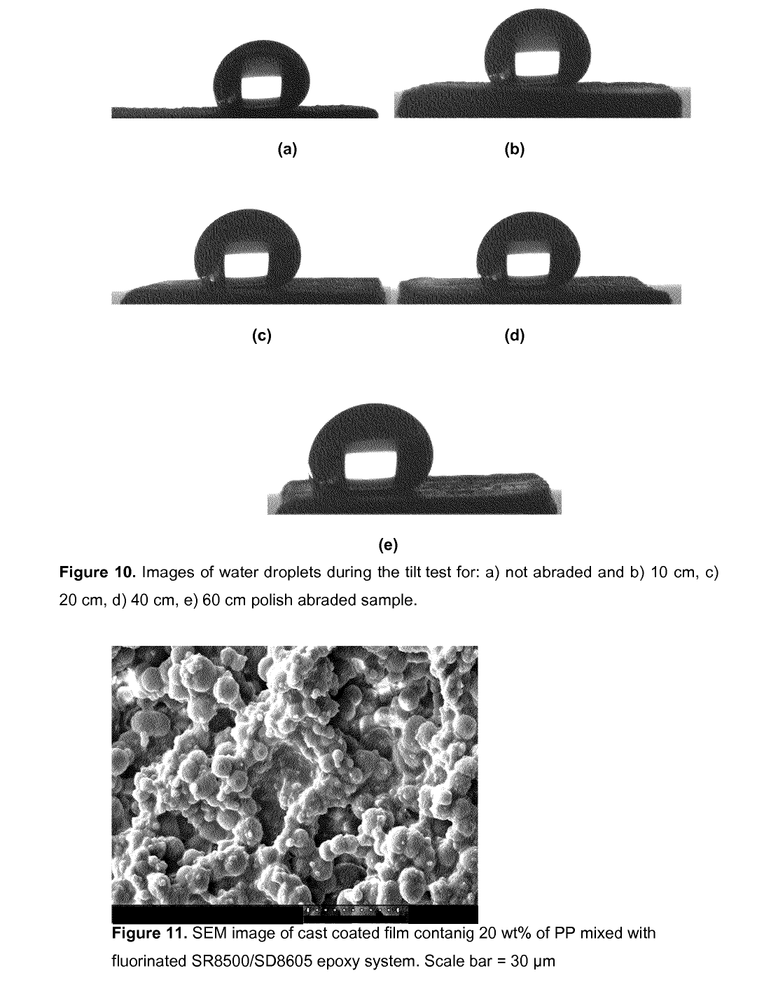

FIG. 10 shows water drop on the surface during tilt experiments, after abrasion;

FIG. 11 is a picture of the coating-air interface of cast coated film containing 20 wt % of PP mixed with a fluorinated SR8500/SD8605 epoxy system; and

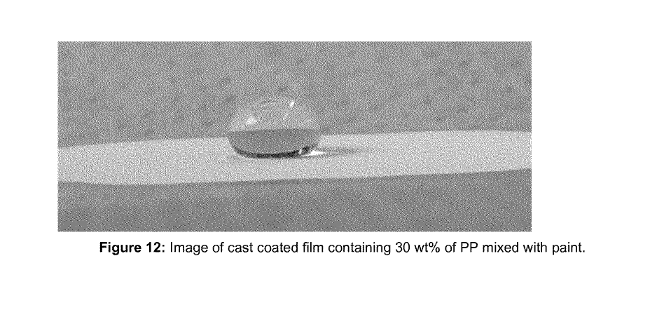

FIG. 12 is a picture of cast coated film containing 30 wt % of PP mixed with paint.

### Example 1 (Spin Coating)

Isotactic polypropylene, PP, (Mw˜12 000 g·mol−1), polyvinyl acetate, PVA, (Mw˜100 000 g·mol−1), poly-styrene, PS, (Mw˜192 000 g·mol−1), polyethylene (low density, d=0.925; melt index: 25 g/10 min at 190° C./2.16kg) and Carnauba wax were purchased from Sigma-Aldrich (Germany). Polycarbonate, PC, was recovered manually from compact discs. The polymers were chosen for their complete solubility in boiling xylene. Mill-Q water drops were used for the determination of contact angles. The solvent was analytical grade p-xylene (Sigma-Aldrich, Germany).

The polymers were dissolved in p-xylene solvent at a 1% wt/wt concentration and at 135° C. under reflux (unless otherwise indicated). A homogeneous solution was obtained, which was easy to spin-coat.

Various blends showing various ratios of polymers were formed by using appropriate weight ratios of polymers in p-xylene. Once the dissolutions were completed, the polymer blend solutions were either casted or immediately spin-coated with a WS-6NPP/lite spinner (Laurell, USA) at 3000 rpm during 30 seconds (unless otherwise indicated) on a glass substrate. This process was repeated three times in order to increase the thickness of the resulting film. A last spin-coating with the same parameters (30 s at 3000 rpm) was performed without adding any solution. Before applying the spin-coating process, the glass substrates were rinsed in acetone, dried and then heated up to 60° C.

The coating was performed at ambient conditions and continued until a 4 mm thick coating was obtained on the glass substrate. The rate of evaporation was varied by using three different conditions. The first provided the highest evaporation rate and used a fan unit placed at 20 cm of a recipient (diameter: 10 cm, height: 1 cm) containing the coated glass substrate. The second did not make use of any fan unit and the recipient was higher (diameter: 5 cm, height: 8 cm). The third method used the same recipient as the second but, in this case, the aperture was covered with a parafilm membrane comprising 20 holes of approximately one millimetre diameter. The resulting evaporation rate was determined by recording the liquid level over time.

The coated surfaces were characterized by their advancing and receding static contact angles (determined with a Krüss DSA100 contact angle analyzer) with a 8 μL water drop. A range of experimental data was generated and statistically analysed. Sliding experiments were performed at slow speed (˜0.06 mm·s−1) over several millimetres of distance while contact angles were recorded. It is assumed that the speed is sufficiently slow to consider that recorded angles are close to the static ones. The sessile drop method consisting in adding and removing minute amounts of liquid during recording of contact angles, was used and superhydrophobicity was evaluated considering the values of the receding static contact angles being below or above the threshold of 135°.

When PP/xylene solutions are left (xylene evaporate, PP crystallizes) at ambient conditions, the resulting surface is superhydrophobic. Carnauba wax and xylene as solvent also result in superhydrophobic surfaces. When modifying the percentage of PP in the above polymer blends it resulted in a dramatic change of the composite surface wettability. With a percentage above 30% the SHI was always 100% and the distribution of the receding static contact angle was close to the one taken on a surface made of pure PP. If the percentage is below 30 w % PP, the receding static contact angle was decreasing drastically to values close to the one taken on smooth surfaces made of pure PVA. The transition to get a completely superhydrophobic composite surface (SHI of 100%) is sharp and generally situated between 25% and 50% PP.

The same trend was also observed when the PP is blended with two other polymers that dissolve in p-xylene: PCP and PS. However, the transition occurred at different ratios of PP to blended polymer. When PP was blended with PCP, the transition was between 60 w % and 70 w % PP. When blending PP with PS, the transition was between 25 w % and 30 w % PP.

Experiments are also performed using PC (polycarbonate) and Carnauba wax instead of PP as the SH-polymer and xylene as solvent. In this case the blend is prepared with PS at 50% of each for the Carnauba wax but also for the PC case. The resulting surfaces (with different spin-coating parameters: 150 rpm instead of 3000 rpm) are superhydrophobic. On the other hand when using the methyl ethyl ketone as solvent with the PC, the ratio SH-polymer (PC)/non-SH-polymer (PS) to get superthydrophobicity has to be increased. This demonstrates that the concept is not specific to the use of PP for the SH-polymer in the blend or the use of xylene as the solvent.

It has been found that the evaporation rate may impact the necessary percentage of PP to be blended in order to obtain superhydrophobic surfaces. It is clear that this parameter has an influence. The amount of PP in the composite surface has to be higher for low and high evaporation rates than for the medium one. Similarly, the polymer concentration is also believed to have an impact.

### Example 2 (PP Powder+PDMS—Spray Based Technique)

The sample is composed by a matrix of PDMS (Poly Dimethyl Siloxane) from silgard Dow-Corning and the SHP (Super Hydrophobic powder) based on polypropylene. The PP grains morphology is shown in FIG. 3. These grains show a size distribution between about 0.1 and 50 μm. Three different types of PDMS were used, more particularly PDMS 182,184 and 186 from Silgard Dow-Corning. The description below relates more specifically to the generation of a film obtained with PDMS 184 and refers to FIG. 3.

First, the PDMS matrix was diluted in cyclohexane in a 1:2 (PDMS: Cyclohexane) weight ratio. Thereafter, the solution was mixed until an homogenous solution was obtained.

A spray gun supplied with compressed air at a pressure of 8-9 bars was used to project the obtained solution and added PP powder onto a surface or substrate. In this example, a SH-PDMS film is formed onto Inox steel. In a first step, PDMS/Cyclohexane solution is sprayed onto the substrate and allowed to dry in an oven at 150° C. for 10 to 20 minutes (to evaporate the solvent and to allow the PDMS to polymerize). In a second step, another layer of PDMS/Cyclohexane and the SHP are sprayed at the same time or the SHP is sputtered after the second layer of PDMS/Cyclohexane has been applied. The sample is again allowed to dry at 150° C., for 10 to 20 minutes. As can be seen from table 1, this technique enables the formation of a film which is SH (Table 1).

TABLE 1
Wetting characteristics of the prepared
SH-PDMS (water drop 30 μl).

| | Mean | Std dev |
|---|---|---|
| Tilt (°) | 0.20 | 0.10 |
| WCA_{Adv}(°) | 150.53 | 6.23 |
| WCA_{Rec}(°) | 146.73 | 3.07 |
| WCAH(°) | 3.80 | 3.89 |

The test was repeated, using a similar spray procedure but an epoxy matrix polymer instead of the PDMS matrix, to form a SH coating on wood (MDF). Similar results were obtained.

### Example 3 (Spray Coating OPS Epoxy Cardanol)

The present example relates to the preparation of a one pot coating composition (OPS: one pot solution) containing 30 wt % of crystalline and/or semi-crystalline polymer mixed in a dissolved epoxy resin to create a PP/epoxy suspension.

A two neck round bottom flask of 100 ml was charged with 1.7 g of isotactic polypropylene and 40 ml of xylene (the example was repeated with limonene instead). The amount of solvent used for this step was varied as shown in Table 2 below. The flask was connected to a Liebig condenser and a magnetic stirrer was introduced into the flask. The flask was heated at 135° C. in an oil bath and the temperature was controlled by a probe sensor in direct contact with the solution. The mixture was heated under reflux under continuous stirring until a homogenous solution was obtained. The solution was cooled at room temperature under stirring.

3.61 g of NC-514 (epoxy-cardanol resin) were dissolved in 10 ml xylene (as stated above, the example was reapeated with limonene instead) in a 20 ml glass bottle equipped with a magnetic stirrer.

Both solutions were combined and heated under reflux, under continuous stirring; until a homogenous solution was produced. The combined solution was cooled at 100° C. under stirring and transferred into a 100 ml glass bottle. The solution was then further cooled at room temperature under manual stirring. The solution was then crushed in a high velocity homogenizer (SilentCrusher M from Heidolph) during 3 min, during which the crusher velocity was slowly increased from 5000 rpm to 12000 rpm.

0.46 g of IPDA (isophorone diamine—curing agent) were dissolved in 5 ml xylene (as stated above, the example was reapeated with limonene instead) in a 20 ml glass bottle, and the solution was combined with the above obtained crushed solution. A further crushing cycle was carried out during 2 min.

The obtained one pot solution (PP/epoxy suspension or dispersion) may be used in accordance with the invention, more particularly as a coating applied on different types of materials. A first application comprises the coating of a glass slide.

A 1 ml aliquot of the OPS obtained was applied by means of an air brushing thechnique using a spray gun (BADGER Air-Brush, model 360 Universal-U.S. Pat. Nos. 5,799,157, 5,366,158). The OPS was sprayed at an air pressure of 20 psi onto a vertical microscope glass slide of 76×26 mm. The spray nozzle was held at a distance of approx. 15 cm from the glass slide to be coated. Spraying was performed by moving the spray gun in forth and back movements, more particularly up and down in this instance.

The coated glass slide was allowed to dry.

The coated glass slide obtained here above was then coated with a further layer of epoxy resin: 3.61 g of cardanol NC-514 and 0.46 g of IPDA (isophorone diamine - curing agent) were dissolved in 15 ml xylene in a 50 ml glass bottle, under stirring. A 1 ml aliquot of the cardanol solution thus obtained was sprayed onto the superhydrophobic coating in the same way as described above. The coated glass slide was then allowed to dry again.

The above described spraying processes were repeated two further times in order to alternate one pot solution and epoxy resin and allowing the solvent to evaporate between sprays.

The resulting coatings were allowed to cure in an oven at 60 or 80° C. during 16 or 23 hours. It was found that the coated glass slide showed superhydrophobic characteristics. In addition the coating obtained showed good resistance to friction and scratches.

The described procedure was also employed to coat diverse kind of surfaces, such as: a textile, steel, roof membrane, tile, umbrella and wood.

A further application of the coating solution of this example consists in spraying a textile sample, like a lab coat sample. The sample was coated with the PP/epoxy suspension as described above and the coated article was allowed to cure. The coated article showed superhydrophic character and good resistance to abrasion. The abrasion resistance was evaluated after passing a gloved finger 10 times over the coated textile. The superhydrophobic character was maintained.

The above described SH coating solution (PP/epoxy suspension) was also used to coat an inox steel sheet as described above and the coated article was allowed to cure. The coated article showed superhydrophic character and good resistance to abrasion. The abrasion resistance was evaluated after abrading firmly with a gloved finger 30 times over the coated sheet using back and forth movement. The superhydrophobic character was maintained.

Yet a further application consists in coating roof membranes with a superhydrophobic coating of the invention. Application of the PP/epoxy coating composition of this example onto a roof membrane lead to superhydrophobic self-cleaning roof cover after evaporation of the solvent. The abrasion resistance was evaluated after abrading firmly with a spatula using back and forth movement 40 times. The capability to repel water was maintained.

Further, the SH coating solution (PP/epoxy suspension) was used to coat a piece of umbrella as described above and the coated article was allowed to cure. The coated article showed superhydrophic character and good resistance to abrasion. The abrasion resistance was evaluated after abrading firmly with a gloved finger 25 times over the coated article using back and forth movements. The capability to repel water was maintained.

The SH coating solution (PP/epoxy suspension) was used to coat a piece of wood (MDF, medium density fiberboard) as described above and the coated article was allowed to cure. The coated article showed superhydrophic character and good resistance to abrasion. The abrasion resistance was evaluated after abrading firmly with a gloved finger 25 times over the coated article using back and forth movement. The superhydrophobic character was maintained.

The SH coating solution (PP/epoxy suspension) as obtained in this Example was further used to coat a roof tile and the coated article was allowed to cure. The coated article showed superhydrophic character and good resistance to abrasion. The abrasion resistance was evaluated after water drop jet impact (spraying water at high pressure of around 8 bar) and sand blasting or particle impact (spraying sand grains at the same pressure; the grains were obtained by sieving through a sieve, the sieve opening of which was 675 μm). The capability to repel water was maintained.

The anti-icing capability of this SH coating was also evaluated. For this test the no coated roof membrane and its corresponding superhidrophobic membrane coated with the PP/epoxy suspension were put on a horizontal plate and dropped a water droplet of 0.2 ml on each surfaces, them the plate was put into the refrigerator at around −22° C. for 5 min. The formation of ice on both surfaces was visually analyzed (FIG. 4). The icing process of the droplet (the droplet becomes white and solid) occurred first for the non coated sample. FIG. 4 shows the comparison of surface anti-icing behavior between a non-coated roof covering membrane sample and its corresponding superhidrophobic sample coated with the PP/epoxy suspension.

Several OPS were prepared varying: 1) the amount, type and molecular weight of crystallizable polymer, as well as 2) the solvent type and concentration in order to study the wetting properties and surface roughness. In addition, the resistance to UV exposure, rain, temperature exposure, boiling water, and peeling resistance of the obtained coatings is shown herein below. These studies were made on a coated glass slide and on a roof membrane.

TABLE 2
Compositions (OPS) used.

| OPS | Characteristics |
|---|---|
| 1 | 30 wt % PP from Aldrich, Mw 12000 g/mol, in 60 ml xylene |
| 2 | 50 wt % PP from Aldrich, Mw 12000 g/mol, in 60 ml xylene |
| 3 | 30 wt % PP from Aldrich, Mw 190000 g/mol, in 30 ml xylene |
| 4 | 30 wt % PP from Aldrich, Mw 190000 g/mol, in 60 ml xylene |
| 5 | 30 wt % PP powder (small grain size, around 7 μm) in |
| | 40 ml xylene |
| 6 | 30 wt % PP powder (big grain size, around 40 μm) in 40 |
| | ml xylene |
| 7 | 30 wt % PP from Aldrich, Mw 190000 g/mol, in 40 ml xylene |
| 8 | 30 wt % PP from Total, Mw 235000 g/mol, in 40 ml xylene |
| 9 | 30 wt % PP from Total, Mw 235000 g/mol, in 40 ml butylal |
| 10 | 50 wt % PP from Aldrich, Mw 12000 g/mol, in 60 ml xylene |
| | (rep OPS2) |
| 12 | 30 wt % PP from total, Mw 235000 g/mol, in 40 ml limonene |
| 13 | 30 wt % PP (50:50 PP 235000 g/mol and PP 12000 g/mol) in |
| | 40 ml xylene |
| 14 | 30 wt % Blue PP, colored PP from Total, Mw 235000 g/mol, |
| | in 40 ml xylene |
| 15 | 30 wt % PLA from Futerro, Mw 221000 g/mol, in 40 ml xylene |
| 16 | 30 wt % HDPE from Aldrich, melt index 42 g/10 min, |
| | in 40 ml xylene |

The coating compositions to be applied by spraying onto roof cover membranes and glass slide substrates are summarized in Table 2. The coatings applied are described in Table 3 below. The nomenclature S300 denotes a sprayed OPS layer, SC denotes a sprayed cardanol layer and X the number of layers. FIG. 5 shows in more detail the layer arrangement during spraying process. For example the coating named SC(S30C-SCx3) is prepared by spraying a first layer of neat cardanol (SC), followed by a second layer of the OPS (S30C) covered by a sprayed layer of neat cardanol, these two last spray processes were repeated 2 times. Further a thin layer of neat epoxy was applied on the coating-air interface to protect the fragile microscale structures and on the coating-substrate interface to improve the sticking behavior.

TABLE 3
Coatings sprayed onto roof membranes and glass surfaces.

| | Characteristics of the coating |
|---|---|
| Membrane name | |
| MA | S30C-SCx3 OPS8 |
| MB | SC(S30C-SCx3) OPS8 |
| MC | SC(S30C-SCx3)-SC OPS13 |
| MD | SC(S30C-SCx3)-SC OPS7 |
| ME | SC(S30C-SCx3)-SC OPS14 |
| MF | SC(S30C-SCx3)-SC OPS15 |
| MG | SC(S30C-SCx3)-SC OPS16 |
| MI | SC(S30C-SCx3)-SC OPS12 |
| Glass name | |
| GA | S30C-SCx3 OPS8 |
| GB | SC(S30C-SCx3)-SC OPS9 |
| GC | SC(S30C-SCx3)-SC OPS13 |
| GD | SC(S30C-SCx3)-SC OPS7 |

The thickness of the sprayed glass slide using the SH coating solution was determined by optical profilometry (Table 4).

TABLE 4
Thickness values of the SH coating solution and the neat epoxy prepared
by spraying a glass slide determined by optical profilometry.

| Glass slide coated with: | Thickness |
|---|---|
| 1 sprayed layer of cardanol (SC) | 2.97 μm ± 0.45 μm |
| 1 sprayed layer of OPS (S30C) | 51.81 μm ± 1 5.70 μm |
| SC(S30C-SCx3) | 129.98 μm ± 47.71 μm |

FIG. 6 shows the roughness morphology at the coating-air interface of the coated membranes determined by SEM. As can be seen, all the coatings displayed a hierarchically roughness in micrometer scale similar to lotus leaf surface morphology. SEM image: a) membrane A, b) membrane B, c) membrane C, d) membrane D, e) membrane F, f) membrane G, and h) membrane I. Left image scale bar=300 μm and right image scale bar=50 μm.

Table 5 summarizes the wetting characteristics, static water contact angle (WCA), advancing water contact angle (WCA_{adv}), receding water contact angle (WCA_{red}), water contact angle hysteresis (WCAH) and tilt angle for the coated membranes determined by goniometry, as well as the values of surface roughness, root mean square roughness (Rq) and mean roughness depth (Rz) determined by optical profilometry. As can be seen, the coated membrane with the best superhydrophobic characteristics is MD (SEM image FIG. 6d). The lowest valley-to-highest peak height of the coating on membrane D is around 257 μm and the Rq roughness is around 48 μm. These last values are higher than the other coated membranes. In this sense, the increase in superhydrophobicity with the increment of the surface roughness can be attributed to two factors: the roughness factor and the air pockets formed by the microscopic pores, on which a substantial fraction of the water drop sits.

TABLE 5
Wetting characteristics and values of surface roughness for the coated
membranes.

| | | | | | Tilt | | |
|---|---|---|---|---|---|---|---|
| | WCA_{static} | WCA_{adv} | WCA_{rec} | WCAH | angle | Rq (μm) | Rz (μm) |
| Sample | (°) | (°) | (°) | (°) | (°) | 20× | 20× |
| MA | 139.4 ± 1.6 | 150.1 ± 2.4 | 147.6 ± 3.6 | 2.4 | 7.4 ± 0.4 | 22.2 ± 1.7 | 170.2 ± 11 |
| MB | 143.8 ± 1.2 | 142.6 ± 2.1 | 140.3 ± 2.1 | 2.3 | 8.5 ± 2.0 | 20.2 ± 6.3 | 147.2 ± 36.3 |
| MC | 142.9 ± 1.2 | 146.5 ± 1.2 | 145.9 ± 0.9 | 0.6 | 6.8 ± 0.9 | 27.5 ± 3.0 | 206.0 ± 23.3 |
| MD | 149.4 ± 0.6 | 149.6 ± 4.4 | 148.8 ± 4.0 | 0.7 | 0 | 48.6 ± 5.7 | 257.2 ± 36.2 |
| MI | 141.2 ± 3.0 | 147.2 ± 2.5 | 143.9 ± 2.3 | 3.3 | 3.1 ± 0.4 | 36.2 ± 4.5 | 226.5 ± 30.6 |

FIG. 7 shows the roughness morphology at the coating-air interface of the coated glass substrates determined by SEM. Similar to the coated membranes, all the coatings displayed a hierarchical roughness in micrometer scale similar to lotus leaf surface morphology.

Table 6 summarizes the wetting characteristics as well as the values of surface roughness for the coated glass substrates. As can be noticed, the tilt angle in which the water drop starts to roll on the surface greatly depends on the roughness.

TABLE 6
Wetting characteristics and values of surface roughness for the coated glass
substrates.

| | | | | | Tilt | | |
|---|---|---|---|---|---|---|---|
| | WCA_{static} | WCA_{adv} | WCA_{rec} | WCAH | angle | Rq (μm) | Rz (μm) |
| Sample | (°) | (°) | (°) | (°) | (°) | 20× | 20× |
| GA | 149.7 ± 1.9 | 153.4 ± 11.4 | 153.1 ± 7.4 | 0.3 | 9.3 ± 1.3 | 26.6 ± 5.4 | 166.4 ± 13.0 |
| GB | 143.0 ± 0.8 | 141.6 ± 1.6 | 138.8 ± 0.7 | 2.8 | 6.4 ± 0.6 | | |
| GC | 138.6 ± 1.2 | 149.5 ± 2.3 | 148.0 ± 3.4 | 1.5 | 4.1 ± 2.0 | 44.8 ± 7.6 | 277.1 ± 54.4 |
| GD | | | | | | 40.6 ± 2.5 | 219.8 ± 9.6 |

Table 7 summarizes the wetting properties of a coated glass substrate after being exposed to UV light.

TABLE 7
SH values after UV test of coated glass substrate.

| | | after 6 h | after 12 h | after 18 h |
|---|---|---|---|---|
| | Before test | UV | UV | UV |
| WCA_{static} (°) | 145.9 ± 0.3 | 144.0 ± 1.6 | 140.5 ± 1.4 | 143.1 ± 0.5 |
| WCA_{adv} (°) | 154.8 ± 12.8 | 148.6 ± 2.7 | 141.2 ± 1.5 | 137.8 ± 1.6 |
| WCA_{rec} (°) | 154.3 ± 12.7 | 145.7 ± 2.1 | 139.1 ± 2.0 | 133.4 ± 2.5 |
| WCAH (°) | 0.4 | 2.9 | 2.1 | 4.4 |
| Tilt angle (°) | 9.2 ± 2.7 | 7.9 ± 1.3 | 10.6 ± 1.2 | 10.7 ± 0.9 |

Table 8 summarizes the wetting properties of a coated roof membrane substrate after being exposed to continuous rain simulation.

TABLE 8
SH values after rain test of coated membrane D.

| | Before | After 7 h | After | After | After | After | After |
|---|---|---|---|---|---|---|---|
| | test | rain | 14 h rain | 21 h rain | 28 h rain | 35 h rain | 42 h rain |
| WCA_{static}(°) | 149. ± 0.55 | 144.7 ± 0.9 | 141.8 ± 0.8 | 140.6 ± 0.7 | 139.3 ± 1.2 | 136.1 ± 1.3 | 138.0 ± 1.0 |
| WCA_{adv}(°) | 149.6 ± 4.4 | 142.4 ± 2.0 | 140.5 ± 1.7 | 139.4 ± 1.8 | 136.6 ± 1.7 | 138.5 ± 0.9 | 138.1 ± 0.5 |
| WCA_{rec}(°) | 148.8 ± 4.0 | 141.7 ± 2.8 | 136.5 ± 1.8 | 139.3 ± 1.2 | 135.1 ± 2.9 | 135. ± 0.64 | 136.5 ± 1.5 |
| WCAH(°) | 0.7 | 0.7 | 4.0 | 0.1 | 1.5 | 2.7 | 1.6 |
| Tilt angle | 0 | 2.1 ± 0.91 | 3.9 ± 0.8 | 5.6 ± 0.2 | 6.4 ± 0.6 | 10.7 ± 0.6 | 10.2 ± 2.0 |
| (°) | | | | | | | |

Table 9 summarizes the wetting properties of a coated steel substrate after being exposed to high temperature (hot plate at around 180° C.).

TABLE 9
SH values after high temperature test of coated steel.

| | | After 1 h | at After 2 h | at After 3 h |
|---|---|---|---|---|
| | Before test | 180° C. | 180° C. | at 180° C. |
| WCA_{static} (°) | 147.4 ± 0.9 | 144.5 ± 0.2 | 141. ± 0.32 | 136.7 ± 0.7 |
| WCA_{adv} (°) | 147.6 ± 0.3 | 144.8 ± 0.7 | 143.7 ± 1.2 | 139.7 ± 2.1 |
| WCA_{rec} (°) | 141.8 ± 1.9 | 135.3 ± 3.4 | 136.7 ± 0.9 | 135.3 ± 1.3 |
| WCAH (°) | 5.8 | 9.5 | 7.0 | 4.4 |

Table 10 summarizes the wetting properties of a coated steel substrate after being exposed to boiling water for different periods of time. The samples were introduced in boiling water;

subsequently they were removed immediately after 20 min and cooled to RT outside the water. This process was repeated 10 times and the wetting properties were measured after each boling step.

TABLE 10
SH values after boiling of coated steel.

| Boiling | | | | | | | | | |
|---|---|---|---|---|---|---|---|---|---|
| water | | 20 | 40 | 60 | 80 | 100 | 140 | 160 | 200 |
| time | 0 min | min | min | min | min | min | min | min | min |
| WCA_{static} | 148.22 | 148.38 | 148.54 | 144.76 | 147.97 | 142.70 | 140.20 | 147.74 | 133.20 |
| WCA_{adv} | 145.61 | 147.34 | 150.48 | 143.70 | 140.78 | 152.60 | 145.95 | 152.78 | 148.84 |
| WCA_{rec} | 142.02 | 144.42 | 142.03 | 139.15 | 136.33 | 151.50 | 143.71 | 141.54 | 133.34 |
| WCAH | 3.62 | 2.92 | 8.45 | 4.55 | 4.44 | 1.10 | 2.24 | 11.24 | 15.50 |

Tape peeling experiments (90° peel) were carried out on the superhydrophobic coating in order to evaluate the particles and substrate adhesion. A flexible tape (6.5 N/m) was applied to the investigated area and 500 g weight was placed on the tape surface for 3 min to insure proper contact with the superhydrophobic coating, the peeling was carried out at a cross rate of 6 mm/s. Finally, the static WCA of coated roof membrane after peeling the tape off was measured. Table 11 summarizes the static WCA of coated roof membrane after peeling test at a cross rate of 6 mm/s.

TABLE 11
Static WCA values after peeling with a normalized building tape.

| | | After 6.5 N/m and |
|---|---|---|
| Sample | Before test | 500 g for 3 min |
| MI | 141.2° ± 3.0° | 141.8° ± 1.3° |

From tables 7, 8, 9, 10 and 11, it can be concluded that the coated substrates presented an adequate resistance to UV, rain, high temperature, boiling water and peeling due to the wetting properties were slightly affected.

Table 12 summarizes the wetting properties of coated roof membranes by spraying OPS prepared with different crystalline polymers. The results show that it is possible to obtain SH coatings with different crystallizable polymers by the approach presented herein. Nevertheless, the dispersion of the crystal grains in the OPS containing HPDE and blue PP was better than the OPS containing PLA, this fact can be due to differences in the rate of crystallization during the cooling step.

TABLE 12
SH values of coated membranes with
different crystallizable polymers.

| | Membrane | Membrane | Membrane |
|---|---|---|---|
| | PLA | HPDE | blue PP |
| WCA_{static} (°) | 139.2 ± 0.6 | 143.2 ± 0.9 | 145.6 ± 1.1 |
| WCA_{adv} (°) | 138.6 ± 2.1 | 150.6 ± 3.6 | 146.0 ± 3.7 |
| WCA_{rec} (°) | 135.1 ± 1.2 | 148.7 ± 3.6 | 145.0 ± 3.5 |
| WCAH (°) | 3.5 | 1.9 | 1.0 |
| Tilt angle (°) | 10.3 ± 0.8 | 2.5 ± 0.5 | 3.9 ± 0.7 |

### Example 4—SHI of Spayed Wood (MDF) and Roof Membrane

The SHI index is defined as the percentage of receding contact angle greater than 135°, and is calculated from drop sliding experiments (water drop volume 5 μl). The OPSs used in this example were prepared using xylene or limonene as solvent and 30 wt % of PP with respect to the epoxy resin. The substrates sprayed for this study were a sample of wood (MDF) and roof membrane sample. In addition, during the spraying process, the room temperature was varied between 19 and 28° C. and the substrate temperature was increased using a hot plate at around 40° C. The SHI value was obtained from around 2500 WCA_{rec} values on a sample

Example 5—Tribometer on Wood (Wear Test-Tangential Shear Experiments)

Tribometer tests were carried out in order to investigate the durabililty of the rough surfaces.

A stainless steel ball with diameter 6 mm was used as the pin. The pin was loaded onto the test sample with a known weight of 2.0 N. A highly stiff elastic arm insures a nearly fixed contact point and thus a stable position in the friction track. Dynamic friction is determined during the test by measuring the deflection of the elastic arm by direct measurement of the change in torque. The rotation speed of the disc was 2 cm/s and the radius of wear track was 2.0 mm. The test was performed at room temperature of about 21-25° C. The coefficient of friction with respect to the sliding distance for diverse sprayed wood substrates is shown in FIG. 8 and the surface morphologies after the wear test at a sliding distance of 2, 6, 20, 40 m for the wood sprayed at room temperature of about 28° C. with the OPS containing limonene are shown in FIG. 9. As can be seen, after 150 laps of wear test some flattening at the surface can be observed, being almost complete flat after 7000 laps of wear under these conditions.

### Example 6—Polishing and Sand Abrasion (Wear Test-Tangential Shear)

The resistance to abrasion of a sprayed roof membrane was evaluated by passing the membrane sample over the sand paper (sand grain size<675 μm) a polish paper (2000 grit) with the superhydrophobic surface facing the abrasion substrate, and a 100 g weight was placed on the membrane sample to insure proper contact with the sand paper. The sample was moved horizontally in one direction (10 cm) at a speed of around 5 cm/s. The wetting properties of the sprayed roof membrane samples are shown in Table 15 and the images of the water drop on the surface during the tilt experiments are shown in FIG. 10.

TABLE 15
Wetting characteristics before and after abrasion (water drop volume 30 μl).

| Roof membrane- | | | | | | |
|---|---|---|---|---|---|---|
| SC-(S30C-SCx4) | Tilt (°) | WCA_{adv}(°) | WCA_{rec}(°) | WCAH | Rq | Rz |
| No abrasion | 1.55 ± 0.64 | 135.95 ± 0.92 | 135.6 ± 0.71 | 0.35 ± 0.21 | 18.77 ± 0.06 | 150.28 ± 18.38 |
| Polish Abrasion— | 0.9 ± 0 | 134.85 ± 0.92 | 133.25 ± 1.48 | 1.6 ± 0.57 | 16.03 ± 1.76 | 116.40 ± 11.10 |
| 10 cm | | | | | | |
| P—20 cm | 0.95 ± 0.21 | 137.7 ± 1.98 | 136.90 ± 2.69 | 0.8 ± 0.71 | 18.41 ± 2.24 | 133.80 ± 25.07 |
| P—40 cm | 0.75 ± 0.35 | 136.35 ± 2.90 | 135.85 ± 3.46 | 0.5 ± 0.57 | 17.57 ± 3.46 | 138.11 ± 33.27 |
| P—60 cm | 1.55 ± 1.06 | 135.1 ± 5.09 | 134.55 ± 5.30 | 0.5 ± 0.21 | 16.08 ± 1.58 | 126.36 ± 4.23 |
| Sand Abrasion— | 0.85 ± 0.35 | 146.52 ± 0.83 | 143.09 ± 0.76 | 3.44 ± 0.08 | 22.76 ± 2.23 | 140.42 ± 3.55 |
| 10 cm | | | | | | |
| S—20 cm | 0.55 ± 0.21 | 157.21 ± 7.91 | 148.5 ± 2.73 | 8.71 ± 5.18 | 22.33 ± 0.82 | 158.00 ± 13.29 |
| S—40 cm | 0.80 ± 0.28 | 150.24 ± 0.26 | 139.43 ± 4.70 | 10.81 ± 3.84 | 20.22 ± 0.56 | 136.83 ± 21.64 |
| S—60 cm | 0.80 ± 0.00 | 150.81 ± 2.62 | 140.32 ± 0.69 | 10.49 ± 3.31 | 18.52 ± 3.07 | 130.72 ± 21.52 |

### Example 7: SH Coating and Epoxy as Sticking And Protective Layer

A coating composition comprising 30 wt % of crystallisable PP and 70 wt % of amorphous polystyrene was sprayed onto a commercial roof membrane. The PP/PS suspension was prepared as follows:

A two neck round bottom flask of 100 ml was charged with 1.7 g of isotactic polypropylene and 40 ml of xylene. The flask was connected to a Liebig condenser and a magnetic stirrer was introduced into the flask. The flask was heated at 135° C. in an oil bath and the temperature was controlled by a probe sensor in direct contact with the solution. The mixture was heated under reflux under continuous stirring until a homogenous solution was obtained. The solution was cooled at room temperature under stirring.

3.95 g of PS were dissolved in 4 ml of THF and 16 ml xylene in a 20 ml glass bottle equipped with a magnetic stirrer.

Both solutions were combined and heated at 135° C. under reflux and continuous stirring until a homogenous solution was ontained. The combined solution was cooled at 100° C. under stirring and transferred into a 100 ml glass bottle. The solution was then further cooled at room temperature. The solution was then crushed in a high velocity homogenizer (SilentCrusher M from Heidolph) during 3 min, during which the crusher velocity was slowly increased from 5000 rpm to 12000 rpm.

Table 16 herein below shows the wetting properties of the surface obtained. The test has been performed with 30 μl water droplets.

TABLE 16
Wetting properties of the sprayed roof membrane.

| | Mean | Std dev |
|---|---|---|
| Tilt (°) | 0.75 | 0.21 |
| WCA_{adv} | 136.75 | 2.05 |
| WCA_{rec} | 136.55 | 2.33 |
| WCAH | 0 | 0.28 |

### Example 8: OPS Fluorinated Petroleum Based Epoxy-Casting

The present example relates to the use of fluorinated epoxy/amine systems employed as matrix for superhydrophobic polymer coatings or as a last thin layer on the coating-air interface in order to protect the fragile microscale structure.

The petroleum based epoxy/amine system is based on epoxy monomer diglycidyl ether of bisphenol A (SR8500) as supplied by Sicomin (France). Polyamine SD8605 as supplied by Sicomin was used as curing agent. Assuming an epoxy equivalent weight (EEW) of 202 g/eq and amine hydrogen equivalent (AHEW) of 70 g/eq, one equivalent weight unit of amine will react with one equivalent weight unit of epoxy resin as per below equation

gamine=gepoxy/202×70

The curing reaction is to be carried out at about 60° C. for about 16 hours.

Flat epoxy surfaces were used as a benchmark for comparison purposes. Films of epoxy were prepared by solvent casting using xylene as solvent and allowing the solvent to evaporate under ambient conditions. While the cardanol based epoxy/amine system was completely miscible in xylene, the SR8500/SD8605 epoxy system requires the use of THF or DMC solvents for the amine curing agent (SD8605).

It is known that epoxy resins show water contact angles (WCA) below 90° . In order to render the epoxy resins (bisphenol A) hydrophobic, a partially fluorinated amine monomer was prepared by reaction of 0.34 g of fluorinated epoxy (heptadecafluorononyl oxirane, Sigma-Aldrich) with a known excess of 1.24 g of SD8605 at about 100° C. for 120 min, in a sealed tube. Afterwards, in order to prepare materials containing from 5 to 10 wt % fluorine in the host polymer, the remaining unreacted amine groups were cured using 3.42 g epoxy monomer SR8500. The films were prepared in the same way as described above.

Static contact angle measurements were performed at several locations across the film on relevant samples and an arithmetic mean and standard deviation for the WCA (water contact angle) were calculated. The WCA of neat SR8500/SD8605 epoxy system was determined to be 84°+/−3°, thus below 90° and therefore hydrophilic. The WCA of fluorinated (10 wt % fluorine content) SR8500/SD8605 epoxy system was determined to be 107°+/−1°, thus hydrophobic.

In order to prepare a superhydrophobic fluorinated epoxy solution containing 20 wt % of PP, 1.25 g of polypropylene and 3.42 g of SR8500 were dissolved in 60 ml xylene and heated under reflux at 135° C. under continuous stirring until a homogeneous solution was obtained. Thereafter, the previous solution of partially fluorinated amine monomer dissolved in 5 ml THF was combined with the PP solution at room temperature and mixed at 7000 rpm in a high velocity homogenizer (SilentCrusher M from Heidolph) for 5 min. The solution of PP and epoxy system was cast coated over a teflon petri dish and the remaining solvent was evaporated at ambient conditions. The curing reaction was carried out at 80° C. for 6 hours.

FIG. 11 shows the roughness morphology at the coating-air interface of cast coated film containing 20 wt % of PP mixed with fluorinated SR8500/SD8605 epoxy system. As can be seen, the coatings are characterized by randomly oriented micro-size PP grains contributing to a significant roughness. It was found that the film (thickness of around 1 mm) showed superhydrophobic properties.

### Example 9: Petroleum Based Epoxy Mixed with High Content of PP

The present example relates to the preparation of a one pot composition containing 50 wt % of crystalline and/or semi-crystalline polymer mixed in a dissolved petroleum based epoxy resin.

A two neck round bottom flask of 100 ml was charged with 5 g of PP and 60 ml of xylene. The flask was connected to a Liebig condenser and a magnetic stirrer was introduced into the flask. The flask was heated at 135° C. in an oil bath and the temperature was controlled by a probe sensor in direct contact with the solution. The mixture was heated under reflux under continuous stirring until a homogenous solution was obtained. The solution was cooled at room temperature under stirring.

2.97 g of SR8500 (petroleum based resin) were dissolved in 10 ml xylene in a 20 ml glass bottle equipped with a magnetic stirrer.

Both solutions were combined and heated under reflux, under continuous stirring; until a homogenous solution was produced. The combined solution was cooled at 100° C. under stirring and transferred into a 100 ml glass bottle. The solution was then further cooled at room temperature under manual stirring and 40 ml of xylene were added. The solution was then crushed in a high velocity homogenizer (SilentCrusher M from Heidolph) during 3 min, during which the crusher velocity was slowly increased from 5000 rpm to 15000 rpm.

1.03 g of SD8605 were dissolved in 5 ml xylene in a 20 ml glass bottle, and the solution was combined with the above obtained crushed solution. A further crushing cycle was carried out during 2 min. The solution of PP and epoxy system was cast coated over a teflon petri dish and the remaining solvent was evaporated at ambient conditions. The curing reaction was carried out at 60° C. for 16 hours. It was found that the film (thickness of around 2 mm) showed superhydrophobic properties on both sides.

### Example 10: Paint Composition

The present example relates to the preparation of a SH paint composition containing 30 wt % crystalline and/or semi-crystalline polymer mixed in a dissolved petroleum based paint.

12 g of paint (petroleum based hydrophobic Satin outdoor paint from Akzo Nobel) and 5.2 g of PP grains (FIG. 3) were mixed using 20 ml of xylene as diluent in a 100 ml glass bottle.

A further crushing cycle was carried out during 2 min at 12000 rpm. The mixture was cast coated over a glass slide (see FIG. 12).

As can be seen on FIG. 12, the obtained paint composition shows SH characteristics after being sprayed and dryed.

In addition, 6 g of paint (Satin-outdoors from AkzoNobel) and 24 g of the OPS (example 3) were mixed in order to prepare a SH paint composition. The mixture was sprayed (air brushing at 8 bar) on a wood sample (MDF). The obtained paint composition shows SH characteristics after being sprayed and dryed.

### Example 11: Adhesive Composition

The present example relates to the preparation of a SH adhesive composition containing 30 wt % crystalline and/or semi-crystalline polymer.

8 g of glue (Fix All Turbo from Soudal, a mastic adhesive based on modified silane polymers, neutral, elastic for every fast bonding) and 3.5 g of PP grains (FIG. 3) were mixed using 20 ml of xylene as diluent in a 100 ml glass bottle. A further crushing cycle was carried out during 2 min at 15000 rpm. The mixture was sprayed (air brushing at 8 bar) on a wood (MDF) sample. The obtained gluecomposition shows SH properties after being sprayed and dryed.

### Example 12: Epoxy Based Paint Compositions

The present example relates to the preparation of a superhydrophobic protective coating containing 50 wt % of a one pot solution (OPS) prepared as per Example 3 mixed with a hydrophilic epoxy based paint. The superhydrophobic coating compositions (OPS) employed are summarized in table 17 below.

TABLE 17
Superhydrophobic coating Compositions (OPS) used.

| OPS | Characteristics |
|---|---|
| 1 | 70 wt % PP from Total (18 g PP pellets, 7.22 g NC514, 0.92 g |
| | IPDA in 195 ml xylene) |
| 2 | 65 wt % PP from Total (15.5 g PP pellets, 7.22 g NC514, 0.92 g |
| | IPDA in 195 ml xylene) |
| 3 | 70 wt % PP from Total (18 g PP pellets, 7.22 g NC514, 0.92 g |
| | IPDA in 190 ml xylene)b |
| 4 | 65 wt % PP from Total (18 g PP pellets, 7.22 g NC514, 0.92 g |
| | IPDA in 180 ml xylene) |

The following epoxy based paints were used for this test:
1. Intercure 420 from AkzoNovel (grey colour): A two component, high solids, low VOC epoxy micaceous iron oxide coating. This product can be used as a barrier coating applied directly to a steel substrate intended for use in non aggressive environments.

WCA_{static}=78°±3°
2. Intergard 475HS from AkzoNovel (white colour): A low VOC, high solids, high build, two component epoxy coating. For use as a high build epoxy coating to improve barrier protection for a range of anti-corrosive coating systems in a wide range of environments including offshore structures, petrochemical plants, pulp and paper mills and bridges. Suitable for use in both maintenance and new construction situations as part of an anti-corrosive coating system.

WCA_{static}=78°±1°

Several epoxy based paint compositions were prepared for spraying on steel sheets. The compositions and application method are shown in table 18:

TABLE 18

| Paint | Procedure |
|---|---|
| 1 | 24 g Intergard 475HS + 24 g OPS 2, Solution crushed in |
| | a high velocity homogenizer (SilentCrusher M from |
| | Heidolph) during 2 min, crusher velocity: 15000 rpm. |
| 2 | 32 g Intergard 475HS + 32 g OPS 4, Solution crushed in |
| | a high velocity homogenizer (SilentCrusher M from |
| | Heidolph) during 2 min, crusher velocity: 15000 rpm. |
| 3 | 32 g Intercure 420 + 32 g OPS 1, Solution crushed in |
| | a high velocity homogenizer (SilentCrusher M from |
| | Heidolph) during 2 min, crusher velocity: 15000 rpm. |
| 4 | 32 g Intergard 475HS + 32 g OPS 1, Solution crushed in |
| | a high velocity homogenizer (SilentCrusher M from |
| | Heidolph) during 2 min, crusher velocity: 15000 rpm. |
| 5 | 32 g Intercure 420 + 24 g OPS 3, Solution crushed in |
| | a high velocity homogenizer (SilentCrusher M from |
| | Heidolph) during 2 min, crusher velocity: 15000 rpm. |

All paints were sprayed on a steel sheet using an air brush set at 8 bar to obtain a homogeneous coating. All the obtained paints showed superhydrophobic characteristics after being sprayed and dried. Interestingly, paint 2 presented particularly good resistance after firm abrasion with a gloved finger.

### Example 13: Coating Compositions Prepared with Superhydrophobic PP Grains

The present example relates to the preparation of superhydrophobic protective coatings containing 30 wt % of PP grains (see FIG. 3) mixed with diverse kinds of commercial polymer based coatings and paints.

The coatings and paints used in this example were as follows:
1. Fillcoat® fibres waterproofing: Waterproofing product based on solvent soluble high polymers. Waterproof finish of roofs, non-walkable terraces, gutters, ridge-pieces, chimney stacks, pipes, etc.
2. Techcolor C203: Paint for roofs based on new technology of self-curing acrylic polymer with nanoscale photocatalytic pigments; this paint is ready for use for the renovation, protection and coloring roof slate or synthetic shingles, fiber cement articles etc.
3. Intergard 475HS from AkzoNovel (white colour): A low VOC, high solids, high build, two component epoxy coating for use as a high build epoxy coating to improve barrier protection for a range of anti-corrosive coating systems in a wide range of environments including offshore structures, petrochemical plants, pulp and paper mills and bridges. Suitable for use in both maintenance and new construction situations as part of an anti-corrosive coating system.

Several coating compositions were prepared for spraying on steel sheets. The compositions and application methods are summarized in table 19:

TABLE 19
Compositions and application method.

| Coating | Characteristics |
|---|---|
| 1 | 12 g Fillcoat-fibres + 5.2 g PP grains + 25 ml xylene. |
| | Solution crushed in a high velocity homogenizer |
| | (SilentCrusher M from Heidolph) during 2 min, |
| | crusher velocity set at 12000 rpm. |
| 2 | 24 g Techcolor C203 + 10.4 g PP grains + 40 ml xylene. |
| | Solution crushed in a high velocity homogenizer |
| | (SilentCrusher M from Heidolph) during 2 min, |
| | crusher velocity set at 12000 rpm. |
| 3 | 24 g Intergard 475HS + 10.4 g PP grains + 25 ml xylene. |
| | Solution crushed in a high velocity homogenizer |
| | (SilentCrusher M from Heidolph) during 2 min, |
| | crusher velocity set at 12000 rpm. |

Paint 1 was applied on a steel sheet by means of a paint roller as well as by spraying using an air brush set at 8 bar. Both application methods conferred superhydrophobic characteristics.

Paint 2 was applied on a glass plate by manual dip coating as well as on a steel sheet by spraying using an air brush set at 8 bar. All application methods provided superhydrophobic characteristics.

Paint 3 was applied on a steel sheet by use of a paint roller as well as by spraying using an air brush set at 8 bar. Both application methods lead to superhydrophobic characteristics.

### Example 13: Superhydrophobic Membrane, Film or Sheet

A superhydrophobic coating composition was prepared by diluting polypropylene in 40 ml xylene at 30 wt. % polypropylene. The polypropylene component consisted in a mixture of 30 wt. % polypropylene showing a MW of 12000 g/mole and 70 wt. % polypropylene showing a MW of 190000 g/mole, both acquired from Aldrich.

A multilayer coating was applied onto onto a steel substrate. The multilayer coating was composed as follows: SCx2-(S30Cx2-SCx2)x4, wherein S300 stands for the superhydrophobic coating composition, SC stands for an epoxy cardanol layer and x represents the number of layers. The epoxy cardanol spray solution was prepared as per Example 3.

After spraying of the relevant layers, the coated substrate was placed into a curing oven and maintained at 60° C. for 16 h.

The coated substrate was then removed from the oven, allowed to cool down to ambient temperature and immersed in xylene solvent until the coating layer detached from the steel substrate surface. The recovered film was deposited onto a Teflon substrate and allowed to dry at room temperature.

The obtained film showed superhydrophobic character on one side as well as interesting wear and abrasion resistance.

1. Superhydrophobic coating composition comprising a solution of crystalline and/or semi-crystalline polymer and of an amorphous hydrophobic matrix polymer in a solvent.

2. Superhydrophobic coating composition of claim 1, wherein the total polymer concentration is at most 30 wt %, preferably no more than 25 wt %, more preferably around 10 wt %, with respect to the solvent.

3-25. (canceled)

26. Superhydrophobic coating composition of claim 1, comprising the crystalline and/or semi-crystalline polymer in a weight ratio to the amorphous hydrophobic polymer such that upon solvent evaporation the coating composition shows superhydrophobic properties and a superhydrophobicity index (SHI) of 70 to 100%, preferably 80 to 100%, more preferably 90 to 100%, most preferably of about 100%.

27. Superhydrophobic coating composition of claim 1, comprising the crystalline and/or semi-crystalline polymer in a weight ratio to the amorphous hydrophobic polymer of 20/80 to 80/20, preferably 25/75 to 75/25, such that upon solvent evaporation the coating composition shows superhydrophobic properties and a superhydrophobicity index (SHI) of 70 to 100%, preferably 80 to 100%, more preferably 90 to 100%, most preferably of about 100%.

28. Superhydrophobic coating composition according to claim 1, wherein the crystalline and/or semi-crystalline polymer is selected from one or more of polypropylene (PP), carnauba wax, polycarbonate (PC), polymethylmethacrylate (PMMA), polylactic acid (PLA), polyhydroxyalkanoates (PHA), polyhydroxybutyrate (PHB), polyamide (PA 11, PA 410), starch-based plastics, cellulose-based pastics, and fibrin-based plastics.

29. Superhydrophobic coating composition according to claim 1, wherein the crystalline and/or semi-crystalline polymer comprises one or more materials selected from homopolymers; copolymers, such as ethylene-propylene block copolymers; random copolymers; graft copolymers, such as polypropylene or polylactic acid grafted with maleic anhydride or acrylic acid; halogenated polymers; and surface oxidized polymers.

30. Superhydrophobic coating composition according to claim 1, wherein the amorphous hydrophobic matrix polymer is selected from polystyrene (PS), polyethylene (PE), low density polyethylene (LDPE) and polychloroprene (PCP), and from polymers which are not hydrophobic by themselves but which are functionalized such as to be hydrophobic, like epoxy resins, polyurethane (PU), polyvinylacetate (PVA), polyacrylic acid, polyacrylate and polymers used in hydrophobic paints.

31. Superhydrophobic coating composition according to claim 1, wherein the solvent is selected from xylene, xylene based solvent system, limonene, and butylal.

32. Superhydrophobic coating composition according to claim 1, further comprising one or more additives.

33. Superhydrophobic polymer composite comprising a matrix of amorphous hydrophobic polymer with dispersed microparticles or nanoparticles of crystallized crystalline and/or semi-crystalline superhydrophobic polymer.

34. Superhydrophobic polymer composite according to claim 33, wherein the crystalline and/or semi-crystalline polymer is in a weight ratio to the amorphous hydrophobic polymer of 20:80 to 80:20, preferably 25:75 to 75:25.

35. Superhydrophobic polymer composite according to claim 33, wherein the crystalline and/or semi-crystalline polymer is selected from polypropylene (PP), carnauba wax, polycarbonate (PC), polymethylmethacrylate (PMMA), polylactic acid (PLA), polyhydroxyalkanoates (PHA), polyhydroxybutyrate (PHB), polyamide (PA 11, PA 410), starch-based plastics, cellulose-based plastics, and fibrin-based plastics.

36. Superhydrophobic polymer composite according to claim 33, wherein the crystalline and/or semi-crystalline polymer comprises one or more materials selected from the group consisting of: homopolymers; copolymers, such as ethylene-propylene block copolymers; random copolymers; graft copolymers; such as polypropylene or polylactic acid grafted with maleic anhydride or acrylic acid; halogenated polymers; and surface oxidized polymers.

37. Superhydrophobic polymer composite according to claim 33, wherein the amorphous hydrophobic matrix polymer is selected from polystyrene (PS), polyethylene (PE), low density polyethylene (LDPE) and polychloroprene (PCP), and from polymers which are not hydrophobic by themselves but which are functionalized such as to be hydrophobic, like epoxy resins, polyurethane (PU), polyvinylacetate (PVA), polyacrylic acid, polyacrylate and polymers used in hydrophobic paints.

38. Superhydrophobic polymer composite according to claim 33, further comprising one or more additives, more particularly selected from wetting agents, thickening agents, hardening agents, plasticizers, stabilizers, colouring agents.

39. Superhydrophobic coating comprising a superhydrophobic polymer composite according to claim 33, showing a superhydrophobicity index (SHI) of 70 to 100%, preferably 80 to 100%, more preferably 90 to 100%, most preferably of about 100%.

40. Superhydrophobic coating according to claim 39, showing self-cleaning properties corresponding to a roll-off contact angle below 10°.

41. Article comprising a substrate at least partially coated with a superhydrophobic polymer composite of claim 1.

42. Article according to claim 41, comprising a substrate at least partially coated by a superhydrophobic coating comprising crystalline and/or semi-crystalline polymer particles dispersed in an amorphous hydrophobic polymer matrix, wherein the matrix polymer is selected in view of a suitable adhesion to the substrate.

43. Process for the preparation of a superhydrophobic coating composition of claim 32, comprising preparing a solution of amorphous hydrophobic matrix polymer and crystalline or semi-crystalline polymer in a suitable solvent, in a ratio of 20:80 to 80:20, preferably 25:75 to 75:25 or 30:70 to 70:30, and at a total polymer concentration of at most 30 wt %, preferably of at most 25 wt %, at a temperature ranging from RT to a temperature below the boiling point of the solvent.

44. Process for the preparation of an article in accordance with claim 41, comprising preparing or providing a coating composition and applying the coating composition onto a substrate, allowing the solvent to evaporate at a temperature comprised between 10 and 70° C. or between 10 and 50° C., and possibly curing.

45. Process for the preparation of an article according to claim 44, further comprising applying onto the polymer coating an epoxy resin layer.

46. Process for the preparation of an article according to claim 44, comprising repeating the steps of claim 44.

47. Process for the preparation of an article according to claim 45, comprising repeating the steps of claim 45.

48. Use of a coating composition of claim 32 in a paint composition to render same superhydrophobic.

49. Membrane or sheet material comprising a superhydrophobic coating according to claim 30.

50. Membrane or sheet material obtainable by the provision of a coating composition according to claim 32, and application thereof on a non-adherent substrate, solvent evaporation at a temperature comprised between 10 and 70° C. or 10 and 50° C., and possibly curing, and withdrawal of a membrane from the substrate.
